(19) United States
(12) Patent Application Publication
(10) Pub. No.: US 2019/0370758 A1
(43) Pub. Date: Dec. 5, 2019

(54) Method for Itemizing and Redeeming Recyclables

(71) Applicant: Christopher Hauser, Walden, NY (US)

(72) Inventor: Christopher Hauser, Walden, NY (US)

(21) Appl. No.: 16/431,653

(22) Filed: Jun. 4, 2019

Related U.S. Application Data
(60) Provisional application No. 62/680,455, filed on Jun. 4, 2018.

(51) Int. Cl. G06Q 10/00

(52) U.S. Cl. CPC G06Q 10/30

(57) ABSTRACT

A system and method for itemizing and redeeming recyclables allows a user to easily and conveniently tally recyclable items in order to redeem the recyclable items for monetary compensation. The system includes at least one remote server which is used to manage a plurality of user accounts and a plurality of facility accounts. The method is a software application that allows a user to fill a digital bag with a plurality of recyclable-item entries. Further, the software application allows a user to output a bag identifier which includes information of the digital bag. The digital bag corresponds to a physical storage device containing the recyclable items and the bag identifier may be a barcode label. The user can be financially compensated for redeeming the associated physical storage device of the digital bag through a facility account which may belong to a recycle processing facility.

The current application claims a priority to the U.S. Provisional Patent application Ser. No. 62/680,455 filed on Jun. 4, 2018.

### FIELD OF THE INVENTION

The present invention generally relates to a software application for managing recyclables. More specifically, a software application that allows a user to itemize, and schedule transport of recyclable materials.

### BACKGROUND OF THE INVENTION

In present times, individuals may redeem certain items such as glass, plastic, and metal cans and bottles for a cash refund offered through state programs operated by California, Connecticut, Delaware, Hawaii, Iowa, Maine, Massachusetts, Michigan, New York, Oregon, and Vermont. These programs require that the recyclable items be transported to a participating recycling facility, the items counted and verified for their eligibility, and the participating facility to pay the recycler (user) their refund. Given the low nature of individual refunds (5 to 10 cents, per eligible item), many individuals do not take advantage of these programs. This not only potentially increases the waste of otherwise recyclable materials, but it also means that the users are effectively missing out on a refund that is their due.

The objective of the present invention is to streamline this process by creating a system for delegating the transport of one user's recyclables to another user for deposit; the second user being paid a fee for their time and effort. The present invention also offers a means of digitized record keeping of the amount and type of recyclables gathered for redemption. To accelerate the process of cataloguing each recyclable item, the present invention includes a scanner/bar code reader that automatically identifies and records the type of item being gathered for redemption. This item's unique identifying code is digitally attached to a virtual bag (mirroring the physical one the actual item is stored in), the bag includes its own unique identifying code printed out and physically affixed to it via this application. In order for a user to redeem their bags, the user brings them to a participating facility themselves or can post their order to a publicly visible exchange, where other users may bid on the bag (ideally for less than the face value of the refunded items). This second group of users (transporters) retrieve the bag from the original user, pay the user for their items, and bring the bags to a participating facility for the full refunded value (covering their “purchase” of the items from the original user, and compensating them for their services). To facilitate these functions, the present invention integrates an interactive map, navigation services, and a means of electronic funds transfer.

### BRIEF DESCRIPTION OF THE DRAWINGS

FIG. 1 is a block diagram illustrating the system of the present invention.

FIG. 2 is a block diagram illustrating another embodiment of the present invention with a printer device.

FIG. 3A is a flowchart illustrating the overall method of the present invention.

FIG. 3B is a continuation of the flowchart from FIG. 3A.

FIG. 4 is a flowchart illustrating the subprocess of finding nearby facility locations.

FIG. 5 is a flowchart illustrating the subprocess that allows a user to select a nearby facility location.

FIG. 6 is a flowchart illustrating the subprocess on retrieving a user location with a global positioning system (GPS) module.

FIG. 7 is a flowchart illustrating the subprocess of retrieving a facility location with a GPS module.

FIG. 8 is a flowchart illustrating the subprocess of using a printer device to output a bag identifier.

FIG. 9 is a flowchart illustrating the subprocess of tallying each recyclable-item entry by item type.

FIG. 10 is a flowchart illustrating the subprocess of calculating the quantity of specified funds in accordance to the contents of the digital bag.

FIG. 11 is a flowchart illustrating the subprocess of a user account being a transporter account for the transport of a digital bag.

FIG. 12 is a flowchart illustrating the subprocess of financially compensating a provider of recyclables and a transporter of recyclables.

FIG. 13 is a flowchart illustrating the subprocess of retrieving a user location with a GPS module.

FIG. 14 is a flowchart illustrating the subprocess of exchanging recyclable materials for monetary compensation between user accounts.

### DETAIL DESCRIPTIONS OF THE INVENTION

All illustrations of the drawings are for the purpose of describing selected versions of the present invention and are not intended to limit the scope of the present invention.

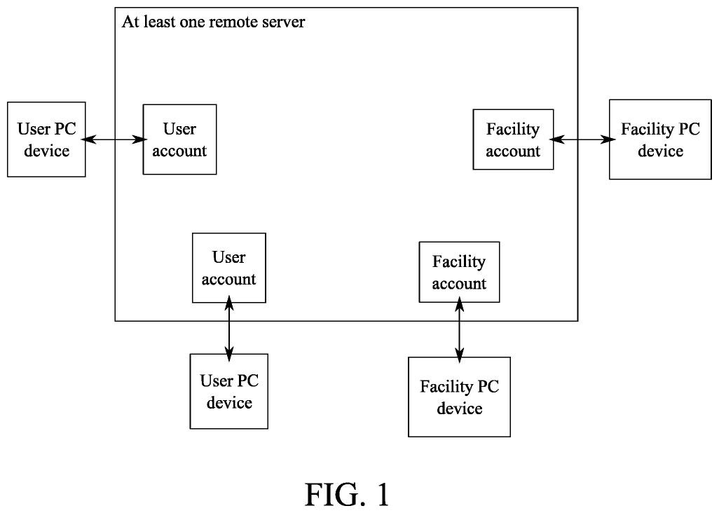

In reference to FIGS. 1 through 14, the present invention is a system and method for itemizing and redeeming recyclables. In more detail, the present invention is a software application that allows a user to itemize recyclable items and redeem the recyclable items for monetary compensation. With reference to FIG. 1, the system of the present invention includes at least one remote server. The remote server is a centralized server that is used to manage a plurality of user accounts (Step A). Each user account is associated with a corresponding user personal computing (PC) device. Further, the corresponding user PC device for each user account is communicably coupled to the remote server. The plurality of user accounts allows an individual to interact with and use the present invention. The user PC device may be any type of computing device such as, but not limited to, a desktop computer, a laptop computer, or a mobile device. Further, the remote server is used to manage a plurality of facility accounts (Step B). Each facility account is associated with a corresponding facility PC device. Similar to the corresponding user PC device for each user account, the corresponding facility PC device for each facility account is communicably coupled to the remote server. The plurality of facility accounts allows a recycling facility to interact with and user the present invention. The facility PC device may be any type of computing device such as, but not limited to, a desktop computer, a laptop computer, or a mobile device. Moreover, the remote server is a central hub used to manage the administrative processes of the present invention and the processed between user accounts and facility accounts.

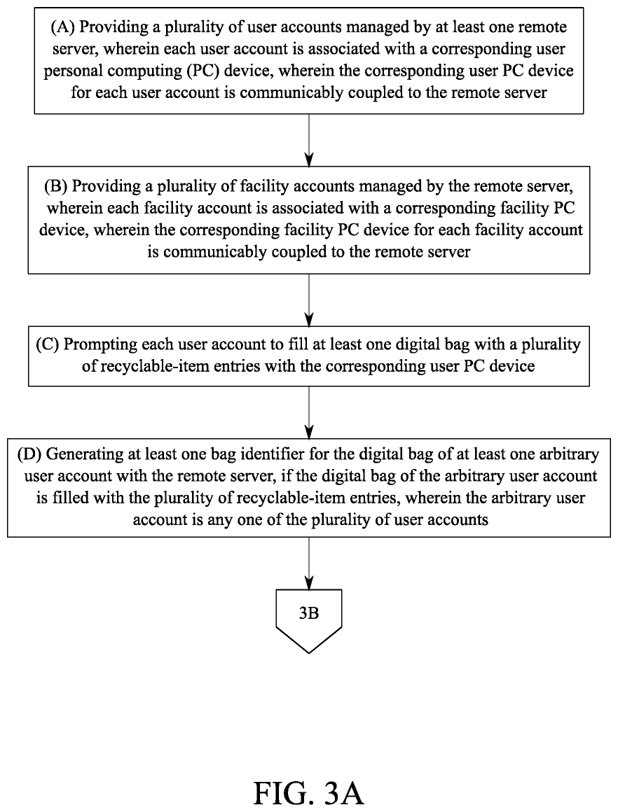

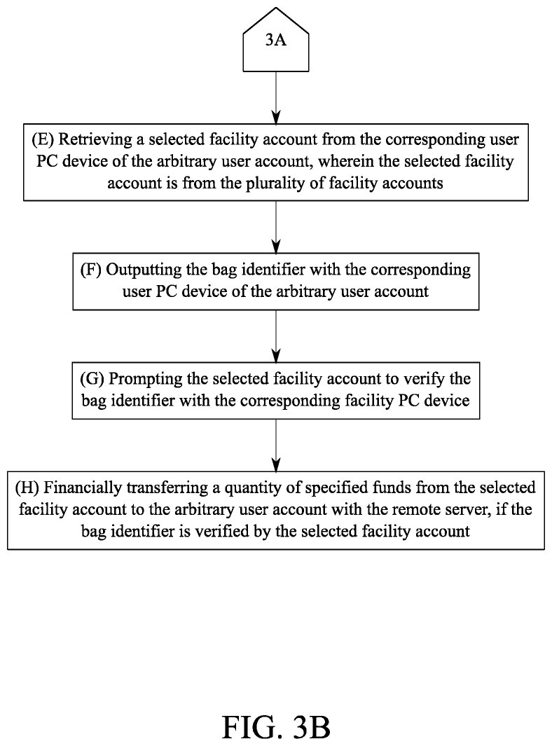

With reference to FIGS. 3A and 3B, the method of the present invention follows an overall process that allows a user to itemize recyclable items and redeem the recyclable items for monetary compensation. Each user account is prompted to fill at least one digital bag with a plurality of recyclable-item entries with the corresponding user PC device (Step C). The digital bag is a digital storage element that corresponds to a physical storage device. Further, the plurality of recyclable-item entries is a set of logged items which are eligible to be recycled. Further, step C allows a user to tally items which are recyclable by simultaneously filling the physical storage device and the digital bag. The remote server generates at least one bag identifier for the digital bag of at least one arbitrary user account (Step D). Step D is processed if the digital bag of the arbitrary user account is filled with the plurality of recyclable-item entries. The arbitrary user account is any one of the plurality of user accounts. Further, the remote server generates an identifier for each bag that is filled by the arbitrary user account. The identifier is a label that includes an order number and is used to identify the digital bag. The identifier may include a scannable portion that outputs information of what is included in the digital bag. A selected facility account is retrieved from the corresponding user PC device of the arbitrary user account (Step E). The selected facility account is from the plurality of facility accounts. The selected facility account is the account of a recycling facility which is either directly or indirectly chosen by the arbitrary user account in order to redeem the recyclable items for monetary compensation. The bag identifier is outputted with the corresponding user PC device of the arbitrary user account (Step F). Step F outputs a physical version of the bag identifier. The user can apply the physical version of the bag identifier onto the associated physical storage device of the digital bag. This allows the user to keep track of each physical storage device associated to each digital bag that is filled with recyclable-item entries during step C. The selected facility account is prompted to verify the bag identifier with the corresponding facility PC device (Step G). The selected facility account can verify the bag identifier by referencing the corresponding physical storage device of the digital bag. The physical storage device is preferably is a physical bag, but the user may use any storage element to carry the recyclable items. A quantity of specified funds is financially transferred from the selected facility account to the arbitrary user account with the remote server (Step H). Step H is processed if the bag identifier is verified by the selected facility account. Step H financially compensates the arbitrary user for each recyclable item that is redeemed. The quantity of specified funds is an amount of monetary compensation determined by the contents within the digital bag and the selected facility account.

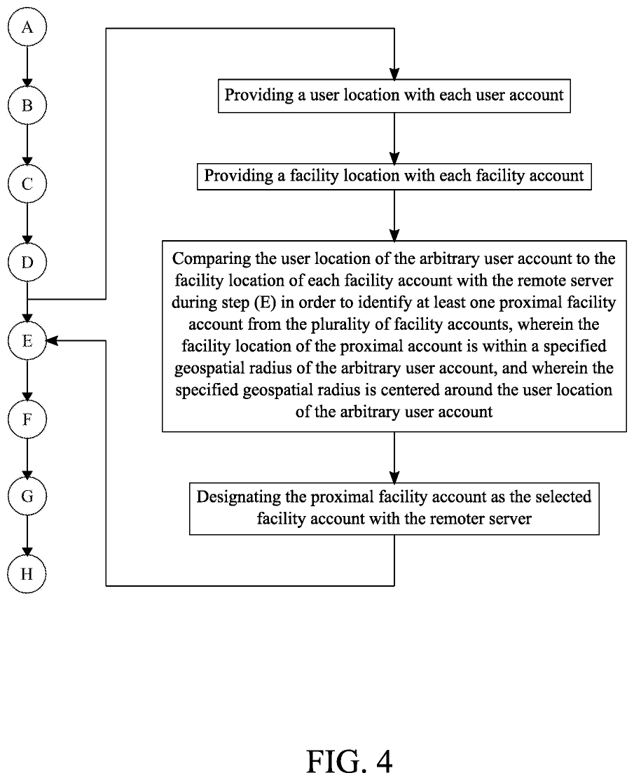

With reference to FIG. 4, the following subprocess finds facility locations of each facility account that are physically near to a user location of a user account. A user location is provided with each user account and a facility location is provided with each facility location. The user location is a physical location which can be inputted by a user or automatically retrieved. Similarly, the facility location is a physical location which can be inputted by a member of a facility or automatically retrieved. The user location of the arbitrary user account is compared to the facility location of each facility account with the remote server during step E in order to identify at least one proximal facility account from the plurality of facility accounts. The facility location of the proximal account is within a specified geospatial radius of the arbitrary user account. The specified geospatial radius is centered around the user location of the arbitrary user account. In more detail, the remote server finds facility locations which are physically near to the user location of the arbitrary user account. The proximal facility account is an account that is associated with a facility location physically near to the user location of the arbitrary user account. The specified geospatial radius can be pre-determined or defined by the arbitrary user account in order to find nearby facility locations by distance. The proximal facility account is designated as the selected facility account with the remote server.

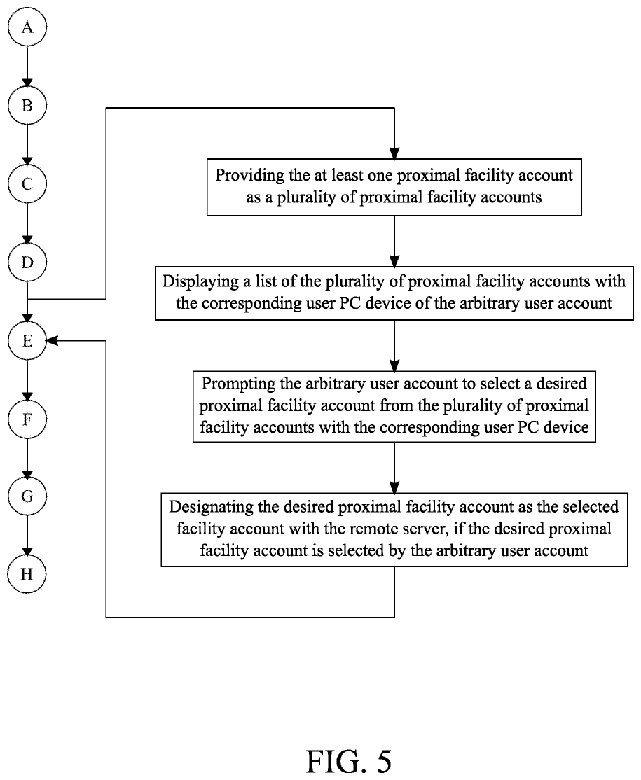

With reference to FIG. 5, the following subprocess allows a user to select a nearby facility location of a facility account. When more than one facility location is found within the specified geospatial radius, then the at least one proximal facility account is provided as a plurality of proximal facility accounts. A list of the plurality of proximal facility accounts is displayed with the corresponding user PC device of the arbitrary user account. This step allows a user to see nearby facility locations of each proximal account. The arbitrary user account is prompted to select a desired proximal facility account from the plurality of proximal facility account with the corresponding user PC device. In further detail, this step allows a user to select a nearby facility location of a facility account. The desired proximal facility account is designated as the selected facility account with the remote server. This step is processed if the desired proximal facility account is selected by the arbitrary user account.

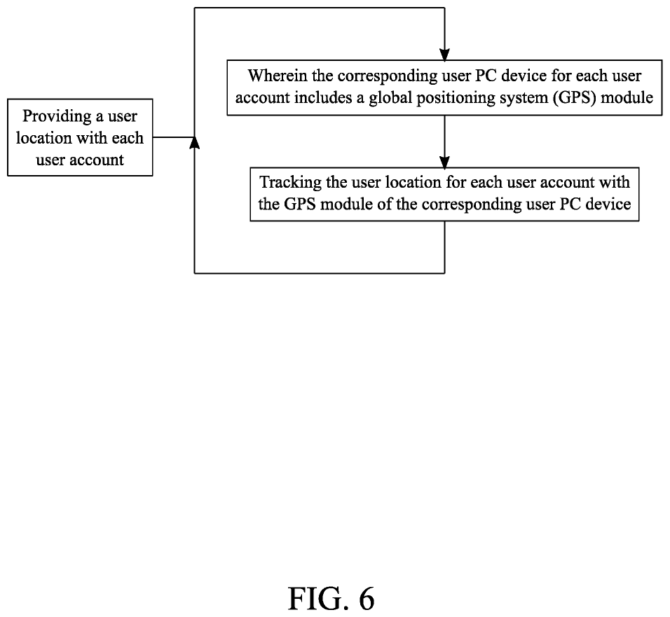

With reference to FIG. 6, the following subprocess tracks a user location of each user account. The corresponding user PC device for each user account includes a global positioning system (GPS) module. The GPS module may be any GPS device used to retrieve the physical location of a computing device of the user account. The user location for each user account is tracked with the GPS module of the corresponding user PC device. This step allows the user location to be automatically retrieved in order to find nearby facility locations.

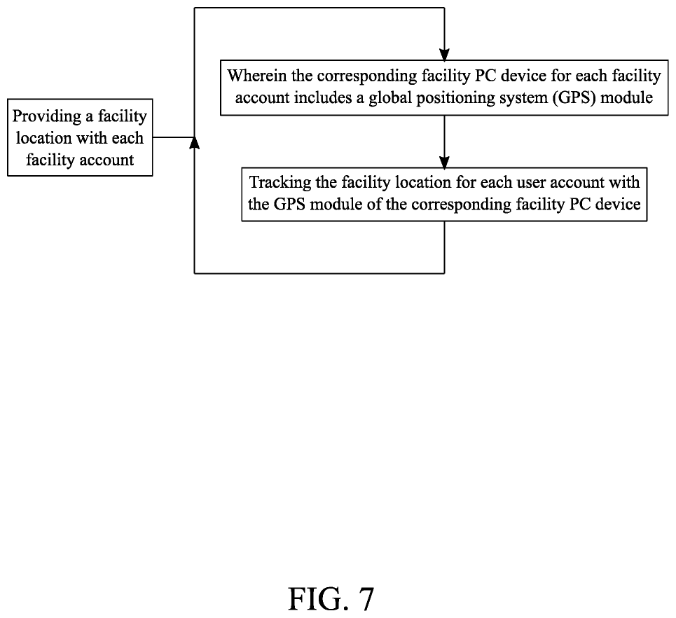

With reference to FIG. 7, the following subprocess tracks a facility location of each facility account. The corresponding facility PC device for each facility account includes a GPS module. The GPS module may be any GPS device used to retrieve the physical location of a computing device of the facility account. The facility location for each facility account is tracked with the GPS module of the corresponding facility PC device. This step allows the remote server to compare facility locations with a user location to identify at least one proximal location.

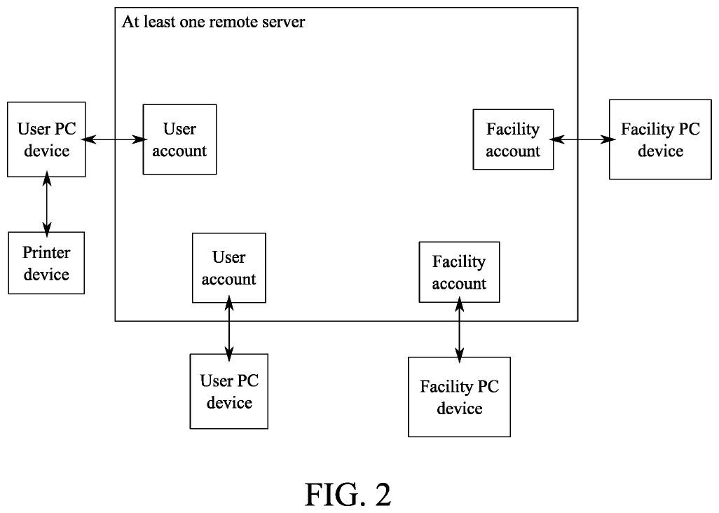

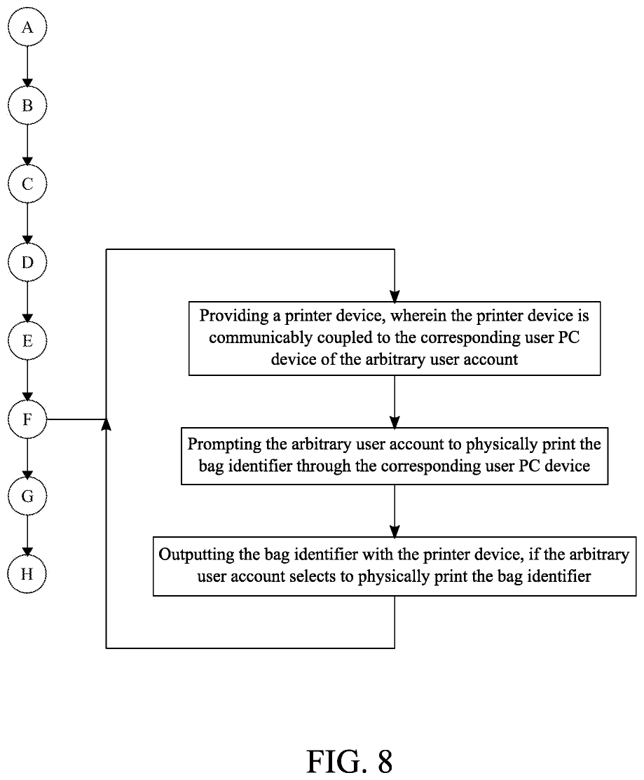

With reference to FIGS. 2 and 8, the system of the present invention may further include a printer device. The printer device is communicably coupled to the corresponding user PC device of the arbitrary user account. The printer device may be any device able to output a physical version of the bag identifier. In more detail, the physical version of the bag identifier may be a barcode label with an adhesive surface. The arbitrary user account is prompted to physically print the bag identifier through the corresponding user PC device. This step allows a user to obtain a physical version of the bag identifier in order to apply the bag identifier to the associated physical storage device of the digital bag. The bag identifier is outputted with the printer device if the arbitrary user account selects to physically print the bag identifier. This step produces a physical version of the bag identifier. After the physical version of the bag identifier is printed, the user can apply the bag identifier onto the associated physical storage device of the digital bag.

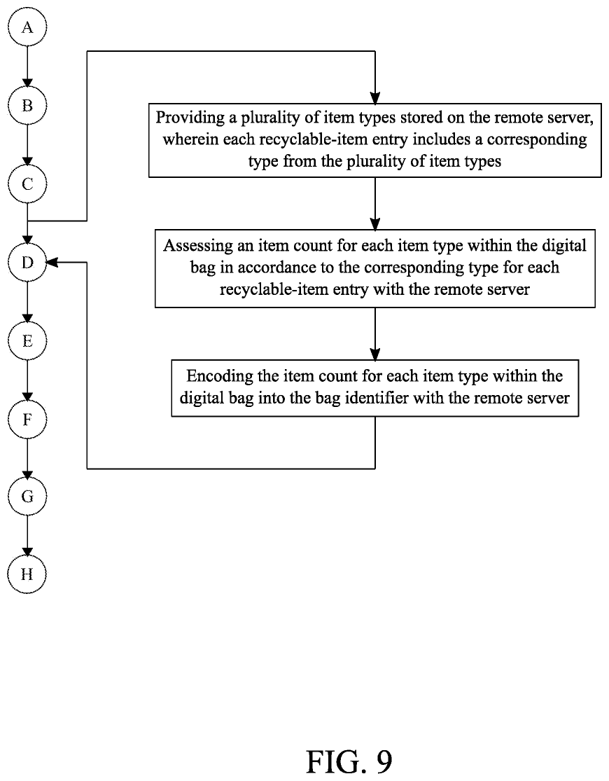

With reference to FIG. 9, the following subprocess tallies each recyclable-item entry by item type. A plurality of item types is stored on the remote server. Each recyclable item includes a corresponding type from the plurality of item types. The plurality of item types is a set of types of item which can be recycled such as, but not limited to, plastic, glass, or metal. An item account is assessed for each item type within the digital bag in accordance to the corresponding type for each recyclable-item entry with the remote server. This step categorizes and tallies each recyclable-item entry based on the item type. The item count for each item type is the fractional amount of recyclable items within the digital bag for a certain item type. Further, this step provides the user with an accurate inventory list of the recyclable items within the digital bag. The item count for each item type within the digital bag is encoded into the bag identifier with the remote server. This step allows the selected facility account to accurately verify the contents of the associated physical storage device of the digital bag with the bag identifier.

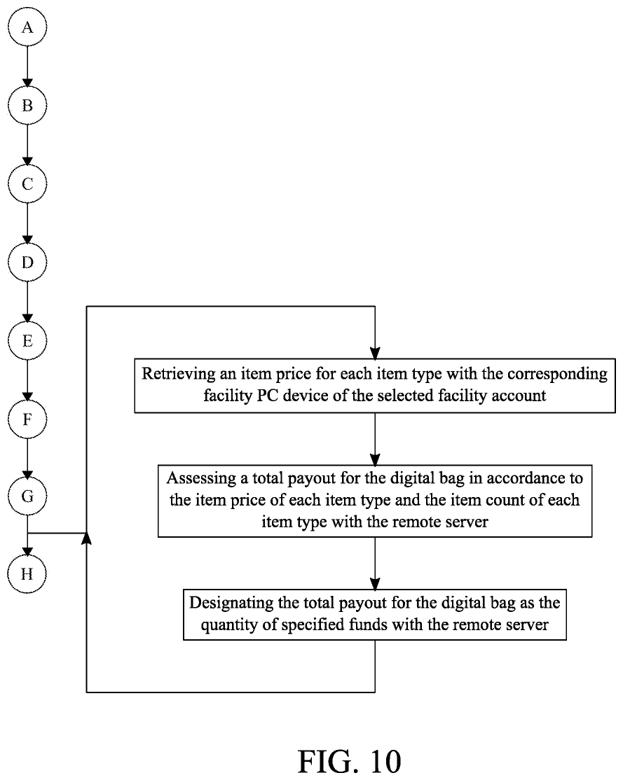

With reference to FIG. 10, the following subprocess is used to calculate the quantity of specified funds in accordance to the digital bag. The item price for each item type is retrieved with the corresponding facility PC device of the selected facility account. This step allows the selected facility account to input the item price for each item type. Further, the item price for each item type may be pre-determined based on the geographical area in which the present invention is in use. A total payout for the digital bag is assessed in accordance to the item price of each item type and item count of each item type with the remote server. The total payout for the digital bag is a monetary value for each recyclable-item entry within the digital bag. The total payout for the digital bag is designated as the quantity of specified funds with the remote server.

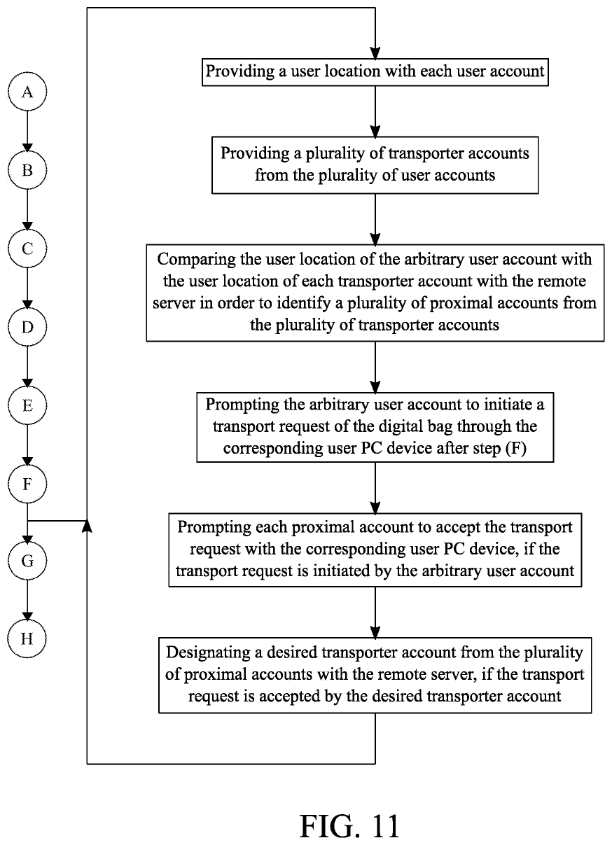

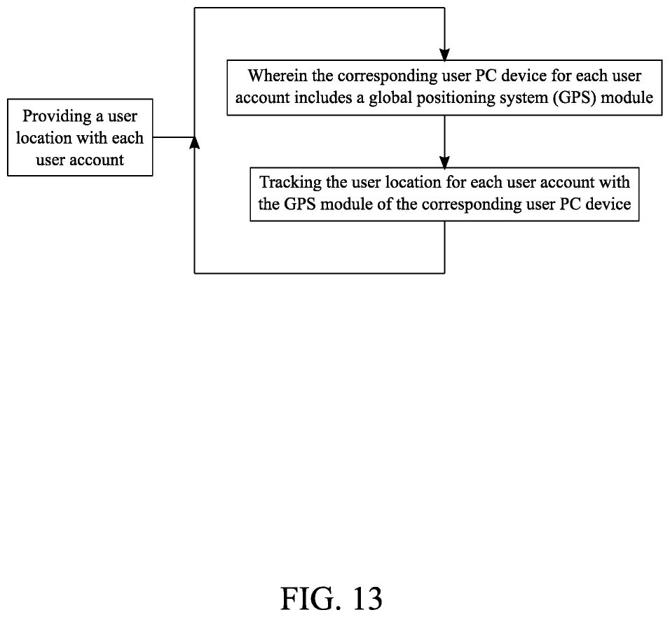

With reference to FIG. 11, the following subprocess allows a user account to be used as a transporter account in order to transport the associated physical storage device of the digital bag. A plurality of transporter accounts from the plurality of user accounts. The plurality of transporter accounts is a set of user accounts that be created by an individual to transport recyclables from the collection area of those recyclables to the facility that process those recyclables. The user location of the arbitrary user account is compared with the user location of each transporter account with the remote server in order to identify a plurality of proximal accounts from the plurality of transporter accounts. In more detail, this step is used to find nearby user accounts that want to transport recyclables. The arbitrary user account is prompted to initiate a transport request of the digital bag through the corresponding user PC device after step F. This step allows a user to request to have recyclables transported by another user of the present invention. Each proximal account is prompted to accept the transport request with the corresponding user PC device. This step is processed if the transport request is initiated by the arbitrary user account. Further, this step allows any transporter account, that is physically near to the arbitrary user account, to accept the transport request. A desired transporter account is designated from the plurality of proximal accounts with the remote server. This step is processed if the transport request is accepted by the desired transporter account. With reference to FIG. 13 and in a preferred embodiment on how to retrieve a user location, the corresponding user PC device for each user account includes a GPS module. The GPS module can be any GPS device able to retrieve the physical location of a computing device. Further, the user location for each user account is tracked with the GPS module of the corresponding user PC device.

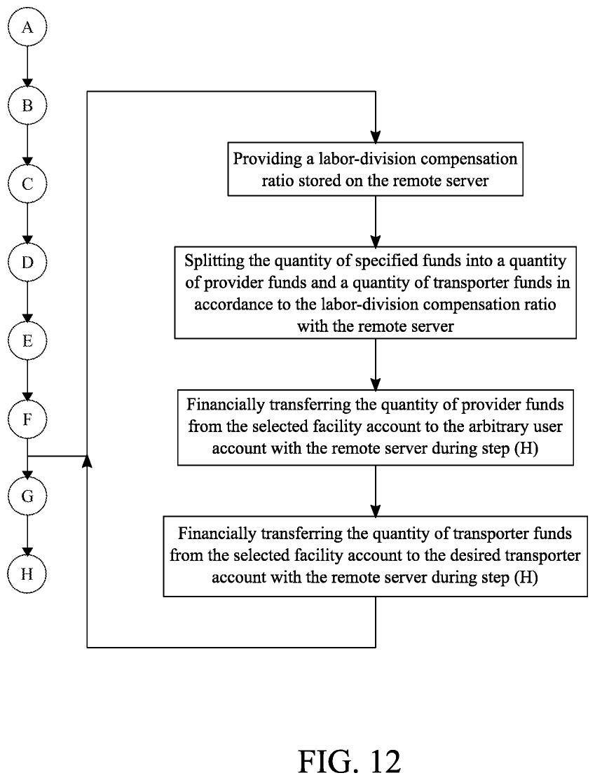

With reference to FIG. 12, the following subprocess is used to split the quantity of specified funds between a provider of recyclables and a transporter of recyclables. A labor-division compensation ratio is stored on the remote server. The labor-division compensation ratio is a pre-determined ratio which is used to split the quantity of specified funds. The quantity of specified funds is split into a quantity of provider funds and a quantity of transporter funds in accordance to the labor-division compensation ratio with the remote server. The quantity of provider funds is a certain amount from the quantity of specified funds that is designated for the user that provides the recyclables. The quantity of transporter funds is a certain amount from quantity of specified funds that is designated for the user that transports the recyclables. The quantity of provider funds is financially transferred from the selected facility account to the arbitrary user account with the remote server during step H. This step financially compensates the arbitrary user account for providing the recyclables. Similarly, the quantity of transporter funds is financially transferred from the selected facility account to the desired transporter account with the remote server during step H. This step financially compensates the desired transporter account for transporter the recyclables.

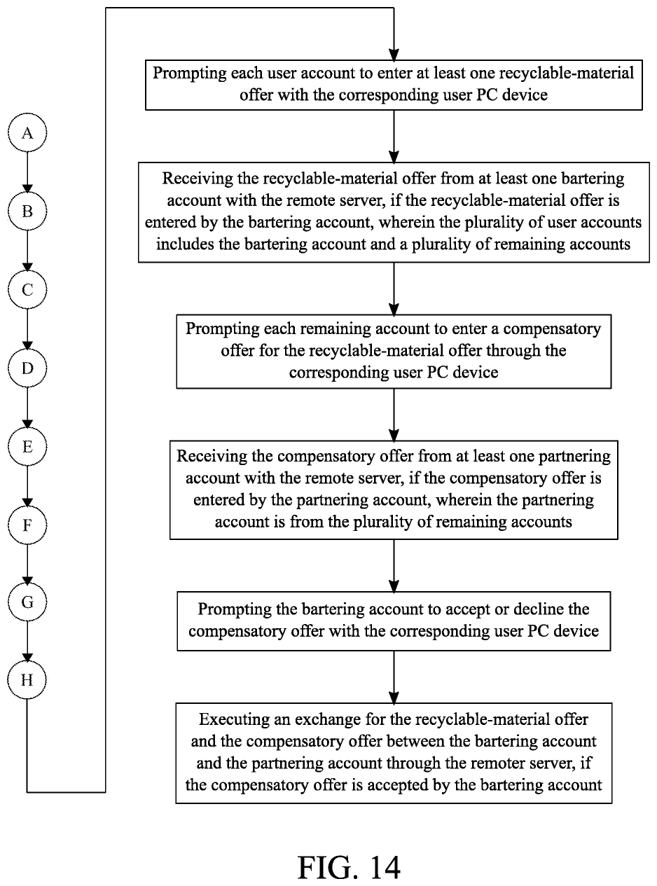

With reference to FIG. 14, the following subprocess allows a user to exchange recyclable materials with another user for monetary compensation. Each user account is prompted to enter at least one recyclable-material offer with the corresponding user PC device. The at least one recyclable-material offer is a post which includes information on a recyclable material for sale and the physical location on where to pickup said recyclable material. The recyclable-material offer from at least one bartering account is received by the remote server, if the recyclable-material offer is entered by the bartering account. The plurality of user accounts includes the bartering account and a plurality of remaining accounts. This step allows user accounts to view the recyclable-material offer if a user is interested in purchasing recyclable materials from another user. Further, the bartering account is the account of a user attempting to sell a recyclable material and the remaining accounts may be accounts of users who are interested in purchasing recyclable materials from other users. Each remaining account is prompted to enter a compensatory offer for the recyclable-material offer through the corresponding user PC device. The compensatory offer is a certain amount of monetary compensation that is offered for purchase of the recyclable material being sold by the bartering account. The compensatory offer from at least one partnering account is received with the remote server, if the compensatory offer is entered by the partnering account. The partnering account is from the plurality of remaining accounts. This step notifies the bartering account of offers made by users who are interested in purchasing the recyclable material. Further, the partnering account is an account of a user who makes an offer for the recyclable material. The bartering account is prompted to accept or decline the compensatory offer with the corresponding user PC device. This step allows the user of the bartering account to accept or decline a certain offer made by another user interested in purchasing the recyclable material. An exchange for the recyclable-material offer and the compensatory offer is executed between the bartering account and the partnering account through the remote server. This step is processed if the compensatory offer is accepted by the bartering account. In more detail, the bartering account receives monetary compensatory in exchange for the recyclable material and the partnering account receives the recyclable material in exchange for an agreed-upon amount of monetary value.

In another embodiment of the present invention, the present invention includes a communication service. The communication service allows users to communicate with one another in order to discuss details of transactions or exchanges. For example, users can discuss details on the transport of recyclables through the communication service. In another example, users can discuss exchange details for recyclable materials through the communication service.

In another embodiment of the present invention, the present invention or the corresponding user PC device can be communicably coupled to an external device. For example, the remote server may be communicably coupled to the external device where the external device may be an external display screen or hard drive. Furthermore, the remote server or the corresponding user PC device may be communicably coupled to the external device where the external device may be a cash register device.

Although the invention has been explained in relation to its preferred embodiment, it is to be understood that many other possible modifications and variations can be made without departing from the spirit and scope of the invention as hereinafter claimed.

What is claimed is:

1. A method for itemizing and redeeming recyclables comprises the steps of:
(A) providing a plurality of user accounts managed by at least one remote server, wherein each user account is associated with a corresponding user personal computing (PC) device, wherein the corresponding user PC device for each user account is communicably coupled to the remote server;
(B) providing a plurality of facility accounts managed by the remote server, wherein each facility account is associated with a corresponding facility PC device, wherein the corresponding facility PC device for each facility account is communicably coupled to the remote server;
(C) prompting each user account to fill at least one digital bag with a plurality of recyclable-item entries with the corresponding user PC device;
(D) generating at least one bag identifier for the digital bag of at least one arbitrary user account with the remote server, if the digital bag of the arbitrary user account is filled with the plurality of recyclable-item entries, wherein the arbitrary user account is any one of the plurality of user accounts;
(E) retrieving a selected facility account from the corresponding user PC device of the arbitrary user account, wherein the selected facility account is from the plurality of facility accounts;
(F) outputting the bag identifier with the corresponding user PC device of the arbitrary user account;
(G) prompting the selected facility account to verify the bag identifier with the corresponding facility PC device; and
(H) financially transferring a quantity of specified funds from the selected facility account to the arbitrary user account with the remote server, if the bag identifier is verified by the selected facility account.

2. The method for itemizing and redeeming recyclables as claimed in claim 1 comprises the steps of:
providing a user location with each user account;
providing a facility location with each facility account;
comparing the user location of the arbitrary user account to the facility location of each facility account with the remote server during step (E) in order to identify at least one proximal facility account from the plurality of facility accounts, wherein the facility location of the proximal account is within a specified geospatial radius of the arbitrary user account, and wherein the specified geospatial radius is centered around the user location of the arbitrary user account; and
designating the proximal facility account as the selected facility account with the remoter server.

3. The method for itemizing and redeeming recyclables as claimed in claim 2 comprises the steps of:
providing the at least one proximal facility account as a plurality of proximal facility accounts;
displaying a list of the plurality of proximal facility accounts with the corresponding user PC device of the arbitrary user account;
prompting the arbitrary user account to select a desired proximal facility account from the plurality of proximal facility accounts with the corresponding user PC device; and
designating the desired proximal facility account as the selected facility account with the remote server, if the desired proximal facility account is selected by the arbitrary user account.

4. The method for itemizing and redeeming recyclables as claimed in claim 2 comprises the steps of:
wherein the corresponding user PC device for each user account includes a global positioning system (GPS) module; and
tracking the user location for each user account with the GPS module of the corresponding user PC device.

5. The method for itemizing and redeeming recyclables as claimed in claim 2 comprises the steps of:
wherein the corresponding facility PC device for each facility account includes a GPS module; and
tracking the facility location for each facility account with the GPS module of the corresponding facility PC device.

6. The method for itemizing and redeeming recyclables as claimed in claim 1 comprises the steps of:
providing a printer device, wherein the printer device is communicably coupled to the corresponding user PC device of the arbitrary user account;
prompting the arbitrary user account to physically print the bag identifier through the corresponding user PC device; and
outputting the bag identifier with the printer device, if the arbitrary user account selects to physically print the bag identifier.

7. The method for itemizing and redeeming recyclables as claimed in claim 1 comprises the steps of:
providing a plurality of item types stored on the remote server, wherein each recyclable-item entry includes a corresponding type from the plurality of item types;
assessing an item count for each item type within the digital bag in accordance to the corresponding type for each recyclable-item entry with the remote server; and
encoding the item count for each item type within the digital bag into the bag identifier with the remote server.

8. The method for itemizing and redeeming recyclables as claimed in claim 7 comprises the steps of:
retrieving an item price for each item type with the corresponding facility PC device of the selected facility account;
assessing a total payout for the digital bag in accordance to the item price of each item type and the item count of each item type with the remote server; and
designating the total payout for the digital bag as the quantity of specified funds with the remote server.

9. The method for itemizing and redeeming recyclables as claimed in claim 1 comprises the steps of:
providing a user location with each user account;
providing a plurality of transporter accounts from the plurality of user accounts;
comparing the user location of the arbitrary user account with the user location of each transporter account with the remote server in order to identify a plurality of proximal accounts from the plurality of transporter accounts;
prompting the arbitrary user account to initiate a transport request of the digital bag through the corresponding user PC device after step (F);
prompting each proximal account to accept the transport request with the corresponding user PC device, if the transport request is initiated by the arbitrary user account; and
designating a desired transporter account from the plurality of proximal accounts with the remote server, if the transport request is accepted by the desired transporter account.

10. The method for itemizing and redeeming recyclables as claimed in claim 9 comprises the steps of:
providing a labor-division compensation ratio stored on the remote server;
splitting the quantity of specified funds into a quantity of provider funds and a quantity of transporter funds in accordance to the labor-division compensation ratio with the remote server;
financially transferring the quantity of provider funds from the selected facility account to the arbitrary user account with the remote server during step (H); and
financially transferring the quantity of transporter funds from the selected facility account to the desired transporter account with the remote server during step (H).

11. The method for itemizing and redeeming recyclables as claimed in claim 9 comprises the steps of:
wherein the corresponding user PC device for each user account includes a GPS module; and
tracking the user location for each user account with the GPS module of the corresponding user PC device.

12. The method for itemizing and redeeming recyclables as claimed in claim 1 comprises the steps of:
prompting each user account to enter at least one recyclable-material offer with the corresponding user PC device;
receiving the recyclable-material offer from at least one bartering account with the remote server, if the recyclable-material offer is entered by the bartering account, wherein the plurality of user accounts includes the bartering account and a plurality of remaining accounts;
prompting each remaining account to enter a compensatory offer for the recyclable-material offer through the corresponding user PC device;
receiving the compensatory offer from at least one partnering account with the remote server, if the compensatory offer is entered by the partnering account, wherein the partnering account is from the plurality of remaining accounts;
prompting the bartering account to accept or decline the compensatory offer with the corresponding user PC device; and
executing an exchange for the recyclable-material offer and the compensatory offer between the bartering account and the partnering account through the remoter server, if the compensatory offer is accepted by the bartering account.
